(19) United States
(12) Patent Application Publication
(10) Pub. No.: US 2026/0280648 A1
(43) Pub. Date: Sep. 17, 2026

(54) ENHANCEMENTS ON L1/L3 MEASUREMENTS

(71) Applicant: Nokia Technologies Oy, Espoo (FI)

(72) Inventors: Lei DU, Beijing (CN); Lars DALSGAARD, Oulu (FI)

(21) Appl. No.: 19/472,158

(22) PCT Filed: Apr. 7, 2023
(86) PCT No.: PCT/CN2023/087106

§ 371 Date: Oct. 3, 2025

(51) Int. Cl. H04B 7/06; H04B 17/309

(52) U.S. Cl. CPC H04B 7/0626; H04B 17/309

(57) ABSTRACT

Embodiments of the present disclosure relate to devices, methods, apparatuses and computer readable storage media of L1/L3 measurements. The method comprises receiving, from a network device, a measurement configuration comprising information configuring at least one CSI-RS on at least one first cell, wherein the at least one first cell is configured without SSB transmission; determining at least one second cell where at least one associated SSB is transmitted, the at least one second cell being different from the at least one first cell; and measuring the at least one CSI-RS on the at least one first cell based on the measurement configuration and the at least one associated SSB. In this way, the L1/L3 measurement accuracy can be improved.

### FIELDS

Various example embodiments of the present disclosure generally relate to the field of telecommunication and in particular, to methods, devices, apparatuses and computer readable storage medium for layer 1 (L1)/layer 3 (L3) measurements.

### BACKGROUND

Synchronization Signal Block (SSB) comprise primary synchronization signals (PSS), secondary synchronization signals (SSS), and/or Physical Broadcast Channel (PBCH) transmissions. SSBs are mainly used for time/frequency synchronization in cell search, beam measurement, beam selection, beam recovery, SCell activation and so on.

For example, a user equipment (UE) may measure SSB transmitted on a cell, or the primary cell (PCell) or a secondary cell (SCell) when carrier aggregation is configured, to acquire time/frequency synchronization and perform L1 measurement, intra-frequency and inter-frequency L3 measurements, e.g., L1 and/or L3 measurements. In other words, the detection of SSBs on the PCell or SCell may be considered as a timing reference for subsequent operations on the cell. However, for purpose of network energy saving, some SCells may be configured without SSB transmission, or the UE is not provided with SSB configuration nor SSB measurement timing configuration (SMTC) for the SCell, which is also referred to as SSB-less SCell operation. Therefore, L1/L3 measurements needs to be improved by taking the SSB-less SCell operation into consideration.

### SUMMARY

The embodiments of disclosure provide one or more apparatuses, one or more corresponding methods, and one or more computer readable medium as disclosed in the appended independent claims. Optional, but advantageous features are disclosed in the appended dependent claims.

In a first aspect of the present disclosure, there is provided an apparatus. The apparatus comprises at least one processor; and at least one memory storing instructions that, when executed by the at least one processor, cause the apparatus at least to: receive, from a network device, a measurement configuration comprising information configuring at least one Channel State Information-Reference Signal, CSI-RS, on at least one first cell, wherein the at least one first cell is configured without Synchronization Signal Block, SSB, transmission; determine at least one second cell where at least one associated SSB is transmitted, the at least one second cell being different from the at least one first cell; and measure the at least one CSI-RS on the at least one first cell based on the measurement configuration and the at least one associated SSB.

In a second aspect of the present disclosure, there is provided an apparatus. The apparatus comprises at least one processor; and at least one memory storing instructions that, when executed by the at least one processor, cause the apparatus at least to: transmit, to a terminal device, a measurement configuration comprising information configuring at least one Channel State Information-Reference Signal, CSI-RS on at least one first cell and an information element of at least one associated SSB transmitted on at least one second cell for measuring the CSI-RS, wherein the at least one first cell is configured without SSB transmission, and the at least one second cell is different from the at least one first cell.

In a third aspect of the present disclosure, there is provided a method. The method comprises: receiving, from a network device, a measurement configuration comprising information configuring at least one Channel State Information-Reference Signal, CSI-RS, on at least one first cell, wherein the at least one first cell is configured without Synchronization Signal Block SSB, transmission; determining at least one second cell where at least one associated SSB is transmitted, the at least one second cell being different from the at least one first cell; and measuring the at least one CSI-RS on the at least one first cell based on the measurement configuration and the at least one associated SSB.

In a fourth aspect of the present disclosure, there is provided a method. The method comprises: transmitting, to a terminal device, a measurement configuration comprising information configuring at least one Channel State Information-Reference Signal, CSI-RS on at least one first cell and an information element of at least one associated SSB transmitted on at least one second cell for measuring the CSI-RS, wherein the at least one first cell is configured without SSB transmission, and the at least one second cell is different from the at least one first cell.

In a fifth aspect of the present disclosure, there is provided a first apparatus. The first apparatus comprises means for receiving, from a network device, a measurement configuration comprising information configuring at least one Channel State Information-Reference Signal, CSI-RS, on at least one first cell, wherein the at least one first cell is configured without Synchronization Signal Block, SSB, transmission; means for determining at least one second cell where at least one associated SSB is transmitted, the at least one second cell being different from the at least one first cell; and means for measuring the at least one CSI-RS on the at least one first cell based on the measurement configuration and the at least one associated SSB.

In a sixth aspect of the present disclosure, there is provided a second apparatus. The second apparatus comprises means for means for transmitting, to a terminal device, a measurement configuration comprising information configuring at least one Channel State Information-Reference Signal, CSI-RS on at least one first cell and an information element of at least one associated SSB transmitted on at least one second cell for measuring the CSI-RS, wherein the at least one first cell is configured without SSB transmission, and the at least one second cell is different from the at least one first cell.

In a seventh aspect of the present disclosure, there is provided a computer readable medium. The computer readable medium comprises instructions stored thereon for causing an apparatus to perform at least the method according to the third aspect.

In a eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example communication environment in which example embodiments of the present disclosure can be implemented;

FIG. 1B illustrates a schematic diagram of an example network framework according to some example embodiments of the present disclosure;

FIG. 2 illustrates a signaling chart illustrating a measurement process according to some example embodiments of the present disclosure;

FIG. 3 illustrates a schematic diagram of the determination of associated SSB for L1 and/or L3 measurements on SSB-less carriers;

FIG. 4 illustrates a flowchart of a method implemented at an apparatus according to some example embodiments of the present disclosure;

FIG. 5 illustrates a flowchart of a method implemented at an apparatus according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second”, . . . , etc. in front of noun(s) and the like may be used herein to describe various elements, these elements should not be limited by these terms. These terms are only used to distinguish one element from another and they do not limit the order of the nouns. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

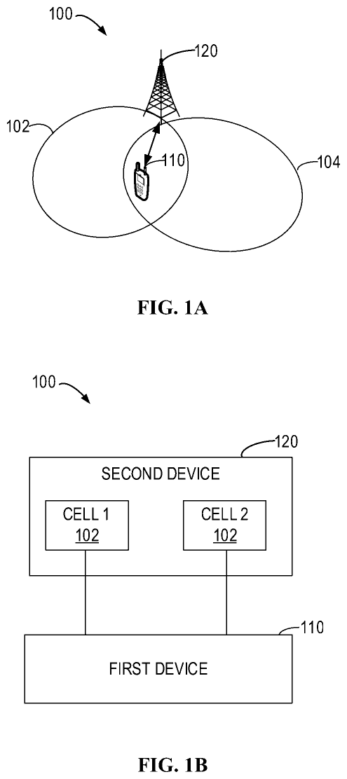

FIG. 1A illustrates an example communication environment 100 in which example embodiments of the present disclosure can be implemented. In the communication environment 100, the first device 110 and the second device 120 may communicate with each other.

The first device 110 may be a terminal device, such as UE. The second device 120 may be a network device, such as a gNB. There may be more than one serving cell configured for the first device 110, for example, the first cell 102 and the second cell 104. The serving cell may include but not limited to, the PCell, the primary secondary cell (PSCell), the SCell and so on.

FIG. 1B illustrates a schematic diagram of an example network framework in FIG. 1A. As shown in FIG. 1B, both the first cell 102 and the second cell 104 are managed by the same network device, i.e., the second device 120. However, in some other example embodiments, the first cell 102 and the second cell 104 may be managed by different network devices, for example, the first cell 102 is managed by the second device 120, and the second cell 104 is managed by a third device (not shown).

In some example embodiments, the second device 120 may configure the first device 110 with a measurement configuration for L1 and/or L3 measurement. For example, the measurement configuration may include information configuring Channel State Information-Reference Signal (CSI-RS) resource on at least one serving cell.

In some example embodiments, according to CSI-RS based measurement requirements, if the measurement configuration includes information regarding associated SSB for the CSI-RS resource, the first device 110 may detect a first cell and measure the CSI-RS only if the associated SSB is detected on the second cell. As previously mentioned, in some cases, a serving cell may be configured without SSB transmission, i.e., the UE is not provided with SSB configuration nor SMTC for the cell. In the example of FIG. 1B, the first cell 102 is given as being configured without SSB transmission, while the second cell 104 is configured with SSB transmission. In FIG. 1B, even though the first cell 102 and the second cell 104 are adjacent from each other, the locations of the first and the second cells may be physically different, and the first cell 102 and the second cell 104 may belong to different devices.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In communication networks, UE performs CSI-RS based measurements to evaluate the cell/beam level channel quality for beam management or mobility purpose. However, CSI-RS based L3 measurement requirements are defined assuming that associated SSB is always configured for the CSI-RS resource to be measured. This implies that the SSB transmission is always configured on the cell, and the UE is required to detect the cell and then measure the CSI-RS only if the associated SSB is detected on the cell. When considering SSB-less (SCell) operation, one scenario is that no SSB transmission is available on a carrier/cell to save energy from network's point of view. In this case, CSI-RS based L1 and/or L3 measurements may not be possible on such carrier/cell as there is no SSB that can be associated with the CSI-RS.

On the other hand, according to the CSI-RS based measurement requirements (e.g., a measurement period for intra-frequency measurement in FRI hereinafter), a carrier specific scaling factor (CSSF) is used to scale (i.e., multiply) a L3 measurement period T_{CSI-RS_measurement_period_intra} by taking the measurements on multiple carriers into account. It is assumed same searcher is used for the measurements on multiple SCells, hence the UE may need alternating the measurements on respective carriers, hence the overall measurement period is extended.

TABLE 1
The measurement period for intra frequency CSI-RS
based measurements without gaps (FR1)

| DRX cycle | T_{CSI-RS}_{_{—}}ₘₑₐₛᵤᵣₑₘₑₙₜ_{_{—}}_{period}_{_{—}}ᵢₙₜᵣₐ |
|---|---|
| No DRX | max(200 ms, ceil(5 × Kₚ_{_{—}}_{CSI-RS}) × CSI-RS |
| | period) × CSSFᵢₙₜᵣₐ |
| DRX cycle ≤ 320 ms | max(200 ms, ceil(1.5 × 5 × Kₚ_{_{—}}_{CSI-RS}) × |
| | max(CSI-RS period, DRX cycle)) × CSSFᵢₙₜᵣₐ |
| DRX cycle > 320 ms | ceil(5 × Kₚ_{_{—}}_{CSI-RS}) × DRX cycle × CSSFᵢₙₜᵣₐ |

NOTE 1:
The requirements apply assuming CSI-RS configuration with {D = 3 with PRBs ≥ 48}. D is frequency domain density for the 1-port CSI-RS for L3 mobility defined in clause 7.4.1 of TS38.211 [6].

TABLE 2
The measurement period for intra frequency CSI-RS
based measurements without gaps (FR2)

| DRX cycle | T_{CSI-RS}_{_{—}}ₘₑₐₛᵤᵣₑₘₑₙₜ_{_{—}}_{period}_{_{—}}ᵢₙₜᵣₐ |
|---|---|
| No DRX | max(400 ms, ceil(Mₘₑₐₛ_{_{—}}_{period}_{_{—}}_{w/o}_{_{—}}_{gaps} × |
| | Kₚ_{_{—}}_{CSI-RS}) × CSI-RS period) × CSSFᵢₙₜᵣₐ |
| DRX cycle ≤ 320 ms | max(400 ms, ceil(1.5 × Mₘₑₐₛ_{_{—}}_{period}_{_{—}}_{w/o}_{_{—}}_{gaps} × |
| | Kₚ_{_{—}}_{CSI-RS}) × max(CSI-RS period, DRX cycle)) × |
| | CSSFᵢₙₜᵣₐ |
| DRX cycle > 320 ms | Mₘₑₐₛ_{_{—}}_{period}_{_{—}}_{w/o}_{_{—}}_{gaps} × DRX cycle × CSSFᵢₙₜᵣₐ |

NOTE 1:
The requirements apply assuming CSI-RS configuration with {D = 3 with PRBs ≥ 48}. D is frequency domain density for the 1-port CSI-RS for L3 mobility defined in clause 7.4.1 of TS38.211 [6].

In the above Tables 1 and 2, CSSFintra is determined based on the following factors:
If the measurement occasions on one carrier is out of gaps or within gaps, i.e., CSSF_{outside_gap,I} and CSSF_{within_gap,I},
The number of configured SCells or secondary carriers to be measured, denoted by N_{SCC_SSB} in table 3 below,
If SSB-based measurement and/or CSI-RS based L3 measurement are configured, e.g., if CSI-RS based L3 measurement is configured, this will add 2 additional layers to be measured for measuring CSI-RS and/or associated SSB, hence the scaling factor is determined by adding two times of the number of secondary carriers. This is reflected in 2*N_{PCC_CSIRS} and 2*N_{SCC_CSIRS}.

TABLE 3
CSSF_{outside}_{_{—}}_{gap, i} scaling factor for SA mode

| | | | | CSSF_{outside}_{_{—}}_{gap, i} |
|---|---|---|---|---|
| | | | | for FR2 SCC where |
| | CSSF_{outside}_{_{—}}_{gap, i} | CSSF_{outside}_{_{—}}_{gap, i} | CSSF_{outside}_{_{—}}_{gap, i} | neighbour cell |
| Scenario | for FR1 PCC | for FR1 SCC | for FR2 PCC | measurement is required |
| FR1 only CA | 1 + N_{PCC}_{_{—}}_{CSIRS} + | N_{SCC}_{_{—}}_{SSB} + Y + 2 × | N/A | N/A |
| | N_{PCC}_{_{—}}_{CCA}_{_{—}}_{RSSI/CO} | N_{SCC}_{_{—}}_{CSIRS} + | | |
| | | N_{SCC}_{_{—}}_{CCA}_{_{—}}_{RSSI/CO} | | |
| FR2 only intra | N/A | N/A | 1 + N_{PCC}_{_{—}}_{CSIRS} | N/A |
| band CA | | | | |
| FR2 only inter | N/A | N/A | 1 + N_{PCC}_{_{—}}_{CSIRS} | 2*(1 + |
| band CA | | | | N_{SCC}_{_{—}}_{CSIRS}_{_{—}}_{FR2}_{_{—}}_{NCM}) ^{Note 3, 5} |
| FR1 + FR2 CA | 1 + N_{PCC}_{_{—}}_{CSIRS} | 2 × (N_{SCC}_{_{—}}_{SSB} + Y + 2* | N/A | 2 × (1 + |
| (FR1 PCell) ^{Note 1} | | N_{SCC}_{_{—}}_{CSIRS} − 1 − | | N_{SCC}_{_{—}}_{CSIRS}_{_{—}}_{FR2}_{_{—}}_{NCM}) ^{Note 3, 5} |
| | | N_{SCC}_{_{—}}_{CSIRS}_{_{—}}_{FR2}_{_{—}}_{NCM}) | | |
| FR1 + FR2 CA | N/A | N_{SCC}_{_{—}}_{SSB} + Y + 2 × | 1 + N_{PCC}_{_{—}}_{CSIRS} | N/A |
| (FR2 PCell) ^{Note 1} | | N_{SCC}_{_{—}}_{CSIRS} | | |

| | CSSF_{outside}_{_{—}}_{gap, i} | CSSF_{outside}_{_{—}}_{gap, i} |
|---|---|---|
| | for FR2 SCC where | for inter-frequency |
| | neighbour cell | MO with no |
| Scenario | measurement is not required | measurement gap |
| FR1 only CA | N/A | N_{SCC}_{_{—}}_{SSB} + Y + 2 × |
| | | N_{SCC}_{_{—}}_{CSIRS} |
| FR2 only intra | N_{SCC}_{_{—}}_{SSB} + Y + 2 × | N_{SCC}_{_{—}}_{SSB} + Y + 2 × |
| band CA | N_{SCC}_{_{—}}_{CSIRS} | N_{SCC}_{_{—}}_{CSIRS} |
| FR2 only inter | 2 × (N_{SCC}_{_{—}}_{SSB} + Y + 2 × | 2 × (_{NSCC}_{_{—}}_{SSB} + Y + 2 × |
| band CA | N_{SCC}_{_{—}}_{CSIRS} − 1 − | N_{SCC}_{_{—}}_{CSIRS} − 1 − |
| | N_{SCC}_{_{—}}_{CSIRS}_{_{—}}_{FR2}_{_{—}}_{NCM}) | N_{SCC}_{_{—}}_{CSIRS}_{_{—}}_{FR2}_{_{—}}_{NCM}) |
| FR1 + FR2 CA | 2 × (N_{SCC}_{_{—}}_{SSB} + Y + 2 × | 2 × (N_{SCC}_{_{—}}_{SSB} + Y + 2 × |
| (FR1 PCell) ^{Note 1} | N_{SCC}_{_{—}}_{CSIRS} − 1 − | N_{SCC}_{_{—}}_{CSIRS} − 1 − |
| | N_{SCC}_{_{—}}_{CSIRS}_{_{—}}_{FR2}_{_{—}}_{NCM}) | N_{SCC}_{_{—}}_{CSIRS}_{_{—}}_{FR2}_{_{—}}_{NCM}) |
| FR1 + FR2 CA | N_{SCC}_{_{—}}_{SSB} + Y + 2 × | N_{SCC}_{_{—}}_{SSB} + Y + 2 × |
| (FR2 PCell) ^{Note 1} | N_{SCC}_{_{—}}_{CSIRS} | N_{SCC}_{_{—}}_{CSIRS} |

^{Note 1}:
Only one FR1 operating band and one FR2 operating band are included for FR1 + FR2 inter-band CA.
Note 2:
Selection of FR2 SCC where neighbour cell measurement is required follows clause 9.2.3.2.
^{Note 3}:
CSSF_{outside}_{_{—}}_{gap, i} = 1 if only one SCell is configured and no inter-frequency MO without gap and only SSB based L3 measurement is configured on SCC; CSSF_{outside}_{_{—}}_{gap, i} = 2 if only one SCell is configured and no inter-frequency MO without gap and either both SSB and CSI-RS based L3 configured or only CSI-RS based L3 measurement is configured on SCC.
Note 4:
Y is the number of configured inter-frequency MOs without MG that are being measured outside of MG; otherwise, it is 0.
^{Note 5}:
Only two NR FR2 operating bands are included for FR2 inter-band CA.
Note 6:
N_{PCC}_{_{—}}_{CSIRS} = 1 if PCC is with either both SSB and CSI-RS based L3 configured or only CSI-RS based L3 measurement configured; otherwise, N_{PCC}_{_{—}}_{CSIRS} = 0.
Note 7:
N_{SCC}_{_{—}}_{CSIRS} = Number of configured SCell(s) with either both SSB and CSI-RS based L3 measurement configured or only CSI-RS based L3 measurement configured
Note 8:
N_{SCC}_{_{—}}_{CSIRS}_{_{—}}_{FR2}_{_{—}}_{NCM} = 1 if FR2 SCC, where neighbour cell measurement is required, is with either both SSB and CSI-RS configured or only CSI-RS measurement configured; otherwise, N_{SCC}_{_{—}}_{CSIRS}_{_{—}}_{FR2}_{_{—}}_{NCM} = 0.
Note 9:
N_{SCC}_{_{—}}_{SSB} = Number of configured SCell(s) with only SSB based L3 measurement configured, which is measured without MG.
Note 10:
N_{PCC}_{_{—}}_{CCA}_{_{—}}_{RSSI/CO} = 1 if PSCC is configured with RSSI/CO measurements without MG when RMTC and SMTC are overlapping; N_{SCC}_{_{—}}_{CCA}_{_{—}}_{RSSI/CO} = Number of MOs for SCell(s) configured with RSSI/CO measurements without MG when RMTC and SMTC are overlapping.

In existing communication networks, CSSF is specified assuming that there is always SSB transmission on the carriers to be measured. When SSB-less operation is considered, there is no SSB to be transmitted on some of the carriers, or the UE is not provided with SSB configuration nor SSB measurement timing configuration (SMTC) for the SCell, which may impact the UE measurement delay requirements on other carriers configured with SSB transmission. Hence the impact to the CSSF from having SSB-less carriers as well as the measurement requirement needs to be identified.

Therefore, a solution is needed to enable L1 and/or L3 measurement on the cell/carrier configured without SSB transmission. The cell/carrier is considered as configured without SSB transmission if the UE is not provided with SSB configuration (absoluteFrequencySSB) nor SMTC configuration for the target SCell. According to the example embodiments of the present disclosure, there is provided an enhanced the L1 and/or L3 measurement mechanism in which the CSI-RS based measurement is associated with SSB transmissions on at least one cell configured with SSB transmission. In this way, even if UE is configured with L1 and/or L3 measurement on a cell/carrier without SSB resources, it will detect associated SSB on other cells configured with SSB transmission, thereby the L1 and/or L3 measurement can be performed smoothly.

Moreover, according to the proposed L1 and/or L3 measurement mechanism, the CSSF is determined by considering the number of cells/carriers configured without SSB transmission (if any). In this way, the accuracy of the L1 and/or L3 measurement mechanism can be improved and the L1 and/or L3 measurement period within which the UE shall be able to measure the cells is optimized/refined.

Example embodiments of the present disclosure will be described in detail below with reference to the accompanying drawings.

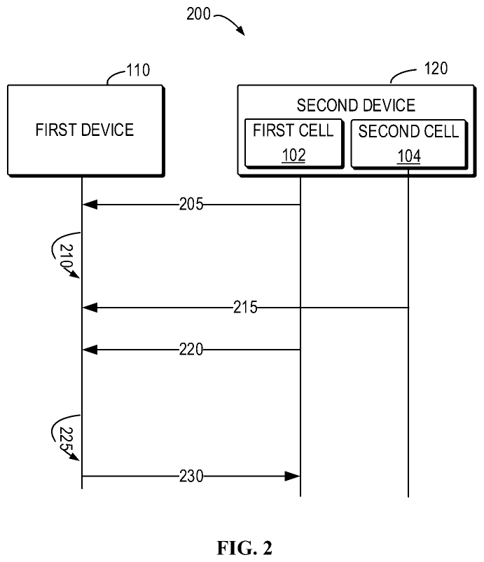

Reference is now made to FIG. 2, which shows a signaling chart 200 for communication according to some example embodiments of the present disclosure. As shown in FIG. 2, the signaling chart 200 involves a first device 110 and a second device 120. For the purpose of discussion, reference is made to FIG. 1B to describe the signaling chart 200. Although a single first device 110 is illustrated in FIG. 2, it would be appreciated that there may be a plurality of terminal devices performing the same/similar operations as described with respect to the first device 110 below.

In the process 200, the first device 110 is configured with carrier aggregation (CA). As shown in FIG. 2, the second device 120 transmits 205 a measurement configuration to the first device 110. The measurement configuration may be related to L1 and/or L3 measurement, such as, CSI-RS based measurement.

In some example embodiments, the measurement configuration may comprise information configuring at least one CSI-RS resource to be measured on at least one first cell 102. The measurement configuration may comprise an associated SSB index related to the CSI-RS resource to be measured. The at least one first cell 102 is configured without SSB transmission. In other words, there is no SSB resources on the first cell 102 or the UE is not provided with SSB configuration nor SSB measurement timing configuration (SMTC) for the first cell 102.

The first device 110 determines 210 at least one second cell 104 where at least one associated SSB is transmitted. The at least one second cell 104 is different from the at least one first cell 102. As SSB transmissions provides a timing reference to the CSI-RS measurement, this can ensure that the CSI-RS based measurement is performed on the first cell 102 based on the detection of the associated SSB on the second cell 104.

In some example embodiments, the CSI-RS may be measured on the at least one first cell 102 after the at least one associated SSB on the at least one second cell 104 is detected, wherein the CSI-RS is measured based on a timing of the at least one associated SSB.

In some example embodiments, the second device 120 may transmit an explicit indication related to the cell on which the at least one associated SSB is located and to be detected. For example, the measurement configuration may comprise an information element (IE) of the at least one associated SSB and of the cell on which the at least one associated SSB is located, and the IE may comprise at least one of an index of the at least one associated SSB (e.g., SSB index) and/or identification information indicating the at least one second cell 104 (e.g., cell ID or cell index).

Alternatively, in some other embodiments, there may be no explicit indication (e.g., implicit indication) on the identification information indicating the at least one second cell 104 provided from the network. For example, if the measurement configuration or the information element (IE) does not include the information of the cell on which the at least one associated SSB is located, or identification information indicating the at least one second cell 104 (e.g., cell ID or cell index), the UE may determine the second cell 104 based on some default setting or principle. In this case, the at least one associated SSB may be assumed to be the SSB resources in use on PCell, PSCell or a serving cell where at least one SSB is transmitted. The first device 110 may select the at least one second cell 104 from the above cells. In these embodiments, it may be considered as a default setting when CSI-RS measurement is configured on a cell without SSB resources.

Additionally, or alternatively, in some embodiments, the at least one associated SSB may be assumed to be detected on a serving or non-serving cell that has the same timing information with the at least one first cell 102, e.g., a co-located cell.

Additionally, or alternatively, in some embodiments, the at least one associated SSB may be assumed to be detected on a serving or non-serving cell with a quasi-colocation relation (QCL) relation with the at least one first cell 102, e.g., if the second device 120 preconfigures the QCL relation between the reference signal i.e., RSs (SSB and/or CSI-RS) on the two cells. In formation related to a quasi-colocation relation between one reference signal in the at least one first cell 102 and another reference signal in the at least one second cell 104 may be provided by the second device 120.

Additionally, or alternatively, in some embodiments, the at least one associated SSB may be assumed to be detected on a serving or non-serving cell where a time difference between the cell and the at least one first cell 102 is below a time difference threshold (e.g., cyclic prefix, CP), as evaluated by the first device 110. As an example, the receive time difference (RTD) may be evaluated by using the tracking reference signaling on the at least one first cell 102.

Additionally, or alternatively, in a case that the first device 110 is configured with L1 and/or L3 measurement on at least one first cell 102 that is configured without SSB transmission, the first device 110 may determine to measure the CSI-RS only, if the associated SSB is detected on the other cell (e.g., the second cell 104).

As an example, the second device 120 may indicate on which cell the associated SSB is to be transmitted as below. The cell index may be added to a CSI-RS resource configuration (e.g., CSI RS Resource Mobility IE). If this IE is not present, and the first device 110 is not provided with SSB configuration (absoluteFrequencySSB) IE nor SMTC configuration IE for the SCell, the first device 110 may assume that the CSI-RS resource is associated with a SSB transmission on PCell or PSCell, or any cell that is co-located with the first cell 102, or any cell that has a QCL-ed RS with the CSI-RS on the first cell 102.

| | |
|---|---|
| CSI-RS-Resource-Mobility ::= | SEQUENCE { |
| csi-RS-Index | CSI-RS-Index, |
| slotConfig | CHOICE { |
| ms4 | INTEGER (0..31), |
| ms5 | INTEGER (0..39), |
| ms10 | INTEGER (0..79), |
| ms20 | INTEGER (0..159), |
| ms40 | INTEGER (0..319) |

},

| | |
|---|---|
| associatedSSB | SEQUENCE { |
| ssb-Index | SSB-Index, |
| cellid | PhysCellId, |
| isQuasiColocated | BOOLEAN |
| } | |

OPTIONAL, -- Need R

| | |
|---|---|
| frequencyDomainAllocation | CHOICE { |
| row1 | BIT STRING (SIZE (4)), |
| row2 | BIT STRING (SIZE (12)) |

},

| | |
|---|---|
| firstOFDMSymbolInTimeDomain | INTEGER (0..13), |
| sequenceGenerationConfig | INTEGER (0..1023), |

}

The at least one associated SSB is transmitted 215 on the second cell 104. The at least one CSI-RS is transmitted 220 on the first cell 102. Accordingly, the first device 110 may detect the at least one associated SSB on the at least one second cell 104. The first device 110 then measures 225 the at least one CSI-RS on the at least one first cell 102 based on the measurement configuration and the at least one associated SSB.

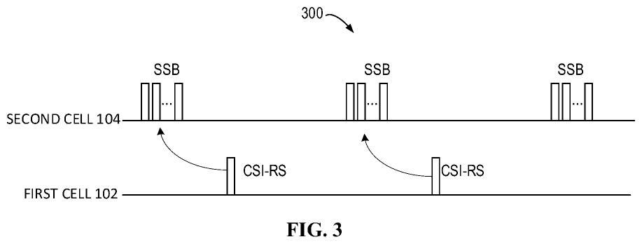

FIG. 3 illustrates a schematic diagram 300 of the determination of associated SSB for L1 and/or L3 measurements on SSB-less carriers. As shown in FIG. 3, the CSI-RS resources to be measured on the first cell 102 are associated with the SSB resources configured on the second cell 104. The first device 110 is required to measure the CSI-RS resources only if the associated SSB transmission is detected on the second cell 104.

The at least one the CSI-RS is measured within a measurement period T_{CSI-RS_measurement_period}. In some example embodiments, the measurement period T_{CSI-RS_measurement_period} may be determined based on the CSSF by considering an actual number of the cells configured without SSB transmission and the associated SSB transmission associated with the CSI-RS resources used for L1 and/or L3 measurements. Hence, it may need to count whether one or more associated SSB is used for all the cells configured without SSB transmission.

In some example embodiments, if the CSI-RS resource on the at least one first cell 102 is associated to the SSB being transmitted on a serving cell, each of the at least one first cell 102 may add only 1 layer to CSSF as the UE has been performing SSB based measurement on the serving cell with SSB transmission. That is, CSSF is increased by N_{SCC_CSI-RS_SSBless}, wherein N_{SCC_CSI-RS_SSBless} represents a number of cells to be measured and configured without SSB resource (i.e., the number of the at least one first cell 102).

In some example embodiments, if the CSI-RS resource on the at least one first cell 102 is associated to the SSB being transmitted on a second cell 104 (which may or may not be a serving cell), and no L3 measurement on the second cell 104 is configured to the first device 110, each of the at least one first cell 102 may add 2 layers to CSSF as the UE need measure associated SSB on the second cell 104 before measuring the CSI-RS on the first cell 102. That is, CSSF is increased by 2*N_{SCC_CSI-RS_SSBless}.

In some example embodiments, if the CSI-RS resources on a plurality of first cells 102 are associated to the SSBs on the same cell 104, the associated SSB layer shall be counted once when determining the CSSF.

According to the above embodiments, by taking the SSB-less carriers into account, the table of CSSF for SA mode may be updated as below.

TABLE 4
CSSF_{outside}_{_{—}}_{gap, i} scaling factor for SA mode

| | | | | CSSF_{outside}_{_{—}}_{gap, i} |
|---|---|---|---|---|
| | | | | for FR2 SCC where |
| | CSSF_{outside}_{_{—}}_{gap, i} | CSSF_{outside}_{_{—}}_{gap, i} | CSSF_{outside}_{_{—}}_{gap, i} | neighbour cell |
| Scenario | for FR1 PCC | for FR1 SCC | for FR2 PCC | measurement is required |
| FR1 only CA | 1 + _{NPCC}_{_{—}}_{CSIRS} + | N_{SCC}_{_{—}}_{SSB} + Y + 2 × | N/A | N/A |
| | N_{PCC}_{_{—}}_{CCA}_{_{—}}_{RSSI/CO} | N_{SCC}_{_{—}}_{CSIRS} + | | |
| | | N_{SCC}_{_{—}}_{SSBless} + | | |
| | | N_{SCC}_{_{—}}_{CCA}_{_{—}}_{RSSI/CO} | | |
| FR2 only intra | N/A | N/A | 1 + N_{PCC}_{_{—}}_{CSIRS} | N/A |
| band CA | | | | |
| FR2 only inter | N/A | N/A | 1 + N_{PCC}_{_{—}}_{CSIRS} | 2*(1 + |
| band CA | | | | N_{SCC}_{_{—}}_{CSIRS}_{_{—}}_{FR2}_{_{—}}_{NCM}) ^{Note 3, 5} |
| FR1 + FR2 CA | 1 + N_{PCC}_{_{—}}_{CSIRS} | 2 × (N_{SCC}_{_{—}}_{SSB} + Y + 2* | N/A | 2 × (1 + |
| (FR1 PCell) ^{Note 1} | | N_{SCC}_{_{—}}_{CSIRS} + | | N_{SCC}_{_{—}}_{CSIRS}_{_{—}}_{FR2}_{_{—}}_{NCM}) ^{Note 3, 5} |
| | | N_{SCC}_{_{—}}_{SSBless} − 1 − | | |
| | | N_{SCC}_{_{—}}_{CSIRS}_{_{—}}_{FR2}_{_{—}}_{NCM}) | | |
| FR1 + FR2 CA | N/A | N_{SCC}_{_{—}}_{SSB} + Y + 2 × | 1 + N_{PCC}_{_{—}}_{CSIRS} | N/A |
| (FR2 PCell) ^{Note 1} | | N_{SCC}_{_{—}}_{CSIRS} + | | |
| | | N_{SCC}_{_{—}}_{SSBless} | | |

| | CSSF_{outside}_{_{—}}_{gap, i} | CSSF_{outside}_{_{—}}_{gap, i} |
|---|---|---|
| | for FR2 SCC where | for inter-frequency |
| | neighbour cell | MO with no |
| Scenario | measurement is not required | measurement gap |
| FR1 only CA | N/A | N_{SCC}_{_{—}}_{SSB} + Y + 2 × |
| | | N_{SCC}_{_{—}}_{CSIRS} |
| FR2 only intra | N_{SCC}_{_{—}}_{SSB} + Y + 2 × | N_{SCC}_{_{—}}_{SSB} + Y + 2 × |
| band CA | N_{SCC}_{_{—}}_{CSIRS} | N_{SCC}_{_{—}}_{CSIRS} |
| FR2 only inter | 2 × (N_{SCC}_{_{—}}_{SSB} + Y + 2 × | 2 × (N_{SCC}_{_{—}}_{SSB} + Y + 2 × |
| band CA | N_{SCC}_{_{—}}_{CSIRS} − 1 − | N_{SCC}_{_{—}}_{CSIRS} − 1 − |
| | N_{SCC}_{_{—}}_{CSIRS}_{_{—}}_{FR2}_{_{—}}_{NCM}) | N_{SCC}_{_{—}}_{CSIRS}_{_{—}}_{FR2}_{_{—}}_{NCM}) |
| FR1 + FR2 CA | 2 × (N_{SCC}_{_{—}}_{SSB} + Y + 2 × | 2 × (N_{SCC}_{_{—}}_{SSB} + Y + 2 × |
| (FR1 PCell) ^{Note 1} | N_{SCC}_{_{—}}_{CSIRS} − 1 − | N_{SCC}_{_{—}}_{CSIRS} − 1 − |
| | N_{SCC}_{_{—}}_{CSIRS}_{_{—}}_{FR2}_{_{—}}_{NCM}) | N_{SCC}_{_{—}}_{CSIRS}_{_{—}}_{FR2}_{_{—}}_{NCM}) |
| FR1 + FR2 CA | N_{SCC}_{_{—}}_{SSB} + Y + 2 × | N_{SCC}_{_{—}}_{SSB} + Y + 2 × |
| (FR2 PCell) ^{Note 1} | N_{SCC}_{_{—}}_{CSIRS} | N_{SCC}_{_{—}}_{CSIRS} |

^{Note 1}:
Only one FR1 operating band and one FR2 operating band are included for FR1 + FR2 inter-band CA.
Note 2:
Selection of FR2 SCC where neighbour cell measurement is required follows clause 9.2.3.2.
^{Note 3}:
CSSF_{outside}_{_{—}}_{gap, i} = 1 if only one SCell is configured and no inter-frequency MO without gap and only SSB based L3 measurement is configured on SCC; CSSF_{outside}_{_{—}}_{gap, i} = 2 if only one SCell is configured and no inter-frequency MO without gap and either both SSB and CSI-RS based L3 configured or only CSI-RS based L3 measurement is configured on SCC.
Note 4:
Y is the number of configured inter-frequency MOs without MG that are being measured outside of MG; otherwise, it is 0.
^{Note 5}:
Only two NR FR2 operating bands are included for FR2 inter-band CA.
Note 6:
N_{PCC}_{_{—}}_{CSIRS} = 1 if PCC is with either both SSB and CSI-RS based L3 configured or only CSI-RS based L3 measurement configured; otherwise, N_{PCC}_{_{—}}_{CSIRS} = 0.
Note 7:
N_{SCC}_{_{—}}_{CSIRS} = Number of configured SCell(s) with either both SSB and CSI-RS based L3 measurement configured or only CSI-RS based L3 measurement configured. This does not include SSB-less carriers.
Note 8:
N_{SCC}_{_{—}}_{CSIRS}_{_{—}}_{FR2}_{_{—}}_{NCM} = 1 if FR2 SCC, where neighbour cell measurement is required, is with either both SSB and CSI-RS configured or only CSI-RS measurement configured; otherwise, N_{SCC}_{_{—}}_{CSIRS}_{_{—}}_{FR2}_{_{—}}_{NCM} = 0.
Note 9:
N_{SCC}_{_{—}}_{SSB} = Number of configured SCell(s) with only SSB based L3 measurement configured, which is measured without MG.
Note 10:
N_{PCC}_{_{—}}_{CCA}_{_{—}}_{RSSI/CO} = 1 if PSCC is configured with RSSI/CO measurements without MG when RMTC and SMTC are overlapping; N_{SCC}_{_{—}}_{CCA}_{_{—}}_{RSSI/CO} = Number of MOs for SCell(s) configured with RSSI/CO measurements without MG when RMTC and SMTC are overlapping.
Note 7:
N_{SCC}_{_{—}}_{SSBless} = Number of configured SSB-less SCell(s) with CSI-RS based L3 measurement configured

Referring back to FIG. 2, in some example embodiments, the first device 110 may then transmit 230 a measurement report comprising measurements result of the CSI-RS to the second device 120.

Although in the above embodiments, the first cell 102 and the second cell 104 are shown as managed by the same device, i.e., the second device 120, however, in some other embodiments, the first cell 102 and the second cell 104 may be managed by different devices, for example, the first cell 102 is managed by the second device 120, and the second cell 104 is managed by a third device (not shown).

According to the example embodiments, there is provided a L1 and/or L3 measurement mechanism in which cells/carriers configured without SSB resources are considered. In particular, if the L1 and L3 measurement is configured on cells/carriers without SSB resources, associated SSBs on other cells can be used as a time reference for the L1 and L3 measurement. In addition, the measurement period is also adjusted based on the actual number of SSB-less carriers and the associated SSBs. As such, the L1 and/or L3 measurement accuracy can be improved.

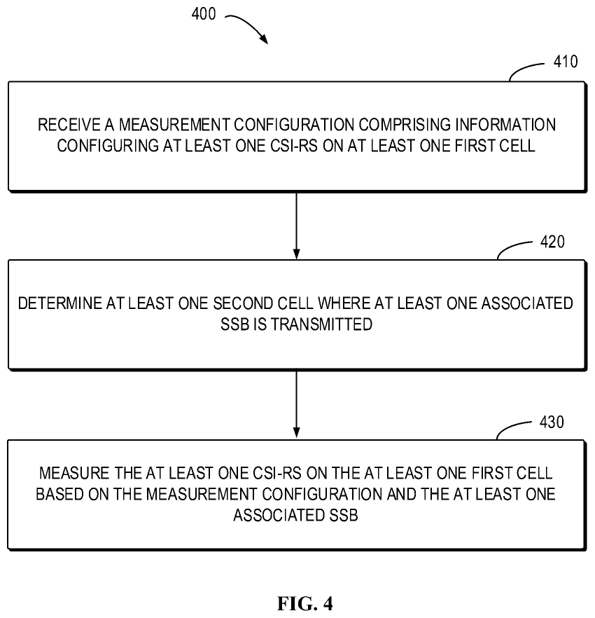

FIG. 4 shows a flowchart of an example method 400 implemented at an apparatus in accordance with some example embodiments of the present disclosure. For example, the apparatus may be implemented by a terminal device (e.g., UE), such as, the terminal device 110 shown in FIG. 1. For the purpose of discussion, the method 400 will be described from the perspective of the terminal device 110 in FIG. 1B.

At block 410, the terminal device 110 receives, from a network device 120, a measurement configuration comprising information configuring at least one CSI-RS on at least one first cell, wherein the at least one first cell is configured without SSB transmission.

At block 420, the terminal device 110 determines at least one second cell where at least one associated SSB is transmitted. The at least one second cell is different from the at least one first cell.

At block 430, the terminal device 110 measures the at least one CSI-RS on the at least one first cell based on the measurement configuration and the at least one associated SSB.

In some example embodiments, the CSI-RS may be measured on the first cell after the at least one associated SSB on the at least one second cell is detected, wherein the CSI-RS is measured based on a timing of the at least one associated SSB.

In some example embodiments, the measurement configuration may comprise an information element of the at least one associated SSB, and the information element comprises at least one of an index of the at least one associated SSB and/or identification information indicating the at least one second cell.

In some example embodiments, the terminal device 110 may detect the at least one associated SSB on the at least one second cell, wherein the at least one second cell is one of the following: a primary cell, a primary secondary cell, or a serving cell where the at least one associated SSB is transmitted.

In some example embodiments, the terminal device 110 may detect the at least one associated SSB on the at least one second cell, wherein the at least one second cell is one of the following:
a serving or non-serving cell that has a same timing information with the at least one first cell,
a serving or non-serving cell with a quasi-colocation relation with the at least one first cell, or
a serving or non-serving cell, wherein a time difference between the serving or non-serving cell and the at least one first cell is below a time difference threshold.

In some example embodiments, the at least one the CSI-RS may be measured within a measurement period, and wherein the measurement period is determined based on a CSSF.

In some example embodiments, the terminal device 110 may determine the CSSF based on a number of the at least one first cell and the at least one second cell where the at least one SSB is transmitted. The terminal device 110 may then determine the measurement period based on the CSSF.

In some example embodiments, if the at least one CSI-RS on the first cell is associated with the at least one SSB on a serving cell, the terminal device 110 may increments a value of the CSSF by the number of the at least one first cell.

In some example embodiments, if the at least one CSI-RS on the at least one first cell is associated with the at least one SSB on the at least one second cell without layer 3 measurement, the terminal device 110 may increment a value of the CSSF by two times of the number of the at least one first cell.

In some example embodiments, if a plurality of CSI-RSs on a plurality of first cells are associated with a plurality of SSBs on the at least one second cell, the terminal device 110 may determine the value of the CSSF further based on a number of the at least one second cell.

In some example embodiments, the measurement configuration may be associated with layer 1 measurement or layer 3 measurement.

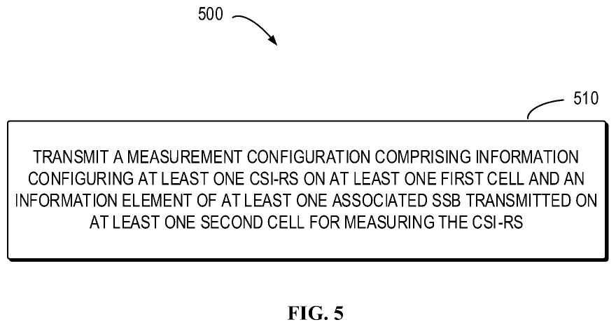

FIG. 5 shows a flowchart of an example method 500 implemented at an apparatus in accordance with some example embodiments of the present disclosure. For example, the apparatus may be implemented by a network device (e.g., gNB), such as, the second device 120 shown in FIG. 1B. For the purpose of discussion, the method 500 will be described from the perspective of the network device 120 in FIG. 1B.

At block 510, the network device 120 transmits, to a terminal device 110, a measurement configuration comprising information configuring at least one CSI-RS on at least one first cell and an information element of at least one associated SSB transmitted on at least one second cell for measuring the CSI-RS, wherein the at least one first cell is configured without SSB transmission, and the at least one second cell is different from the at least one first cell.

In some example embodiments, the measurement configuration may comprise an information element of at least one associated SSB transmitted on at least one second cell for measuring the CSI-RS.

In some example embodiments, the information element may comprise at least one of: an index of the at least one associated SSB, or identification information indicating the at least one second cell.

In some example embodiments, the at least one second cell may comprise one of the following: a primary cell, a primary secondary cell, or a serving cell where the at least one associated SSB is transmitted.

In some example embodiments, the second cell may comprise one of the following:
a serving or non-serving cell that has a same timing information with the at least one first cell,
a serving or non-serving cell with a quasi-colocation relation with the at least one first cell, or
a serving or non-serving cell, wherein a time difference between the serving or non-serving cell and the at least one first cell is below a time difference threshold.

In some example embodiments, the network device 120 may be further caused to transmit, to the terminal device 110, information related to a quasi-colocation relation between one reference signal in the at least one first cell and another reference signal in the at least one second cell.

In some example embodiments, a first apparatus capable of performing any of the method 400 (for example, the terminal device 110 in FIG. 1B) may comprise means for performing the respective operations of the method 400. The means may be implemented in any suitable form. For example, the means may be implemented in a circuitry or software module. The first apparatus may be implemented as or included in the terminal device 110 in FIG. 1B.

In some example embodiments, the first apparatus comprises: means for receiving, from a network device, a measurement configuration comprising information configuring at least one Channel State Information-Reference Signal, CSI-RS, on at least one first cell, wherein the at least one first cell is configured without Synchronization Signal Block, SSB, transmission; means for determining at least one second cell where at least one associated SSB is transmitted, the at least one second cell being different from the at least one first cell; and means for measuring the at least one CSI-RS on the at least one first cell based on the measurement configuration and the at least one associated SSB.

In some example embodiments, the CSI-RS is measured on the first cell after the at least one associated SSB on the at least one second cell is detected, wherein the CSI-RS is measured based on a timing of the at least one associated SSB.

In some example embodiments, the measurement configuration comprises an information element of the at least one associated SSB, and the information element comprises at least one of an index of the at least one associated SSB or identification information indicating the at least one second cell.

In some example embodiments, the first apparatus further comprises means for detecting the at least one associated SSB on the at least one second cell, wherein the at least one second cell is one of the following: a primary cell, a primary secondary cell, or a serving cell where the at least one associated SSB is transmitted.

In some example embodiments, the first apparatus comprises means for detecting the at least one associated SSB on the at least one second cell, wherein the at least one second cell is one of the following: a serving or non-serving cell that has a same timing information with the at least one first cell, a serving or non-serving cell with a quasi-colocation relation with the at least one first cell, or a serving or non-serving cell, wherein a time difference between the serving or non-serving cell and the at least one first cell is below a time difference threshold.

In some example embodiments, the at least one the CSI-RS is measured within a measurement period, and wherein the measurement period is determined based on a carrier specific scaling factor, CSSF.

In some example embodiments, the first apparatus comprises means for determining the CSSF based on a number of the at least one first cell and the at least one second cell where the at least one associated SSB is transmitted; and means for determining the measurement period based on the CSSF.

In some example embodiments, the first apparatus comprises means for in accordance with a determination that the at least one CSI-RS on the first cell is associated with the at least one SSB on a serving cell, incrementing a value of the CSSF by the number of the at least one first cell.

In some example embodiments, the first apparatus comprises means for in accordance with a determination that the at least one CSI-RS on the at least one first cell is associated with the at least one SSB on the at least one second cell without layer 3 measurement, incrementing a value of the CSSF by two times of the number of the at least one first cell.

In some example embodiments, the first apparatus comprises means for in accordance with a determination that a plurality of CSI-RSs on a plurality of first cells are associated with a plurality of SSBs on the at least one second cell, determining the value of the CSSF further based on a number of the at least one second cell.

In some example embodiments, the measurement configuration is associated with layer 1 measurement or layer 3 measurement.

In some example embodiments, a second apparatus capable of performing any of the method 500 (for example, the network device 120 in FIG. 1B) may comprise means for performing the respective operations of the method 500. The means may be implemented in any suitable form. For example, the means may be implemented in a circuitry or software module. The second apparatus may be implemented as or included in the network device 120 in FIG. 1B.

In some example embodiments, the second apparatus comprises means for transmitting, to a terminal device, a measurement configuration comprising information configuring at least one Channel State Information-Reference Signal, CSI-RS on at least one first cell and an information element of at least one associated SSB transmitted on at least one second cell for measuring the CSI-RS, wherein the at least one first cell is configured without SSB transmission, and the at least one second cell is different from the at least one first cell.

In some example embodiments, the information element comprises at least one of: an index of the at least one associated SSB, or identification information indicating the at least one second cell.

In some example embodiments, the measurement configuration comprises an information element of at least one associated SSB transmitted on at least one second cell for measuring the CSI-RS.

In some example embodiments, the at least one second cell comprises one of the following: a primary cell, a primary secondary cell, or a serving cell where the at least one associated SSB is transmitted.

In some example embodiments, the second cell comprises one of the following: a serving or non-serving cell that has a same timing information with the at least one first cell, a serving or non-serving cell with a quasi-colocation relation with the at least one first cell, or a serving or non-serving cell, wherein a time difference between the serving or non-serving cell and the at least one first cell is below a time difference threshold.

In some example embodiments, the second apparatus further comprises means for transmitting, to the terminal device, information related to a quasi-colocation relation between one reference signal in the at least one first cell and another reference signal in the at least one second cell.

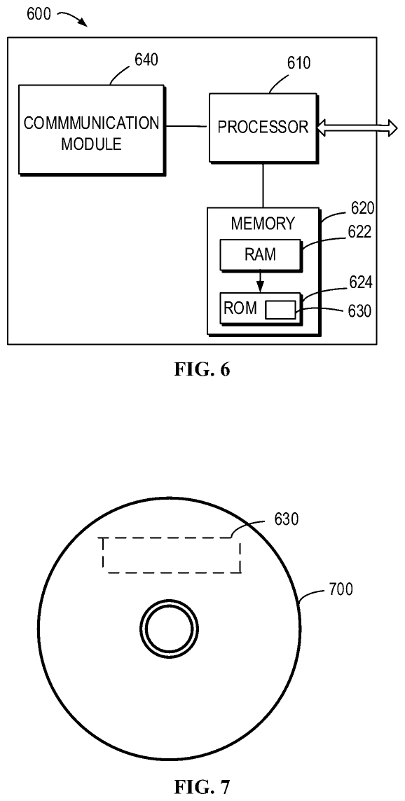

FIG. 6 is a simplified block diagram of a device 600 that is suitable for implementing example embodiments of the present disclosure. The device 600 may be provided to implement a communication device, for example, the terminal device 110 or the network device 120 as shown in FIG. 1B. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus comprising:
at least one processor; and
at least one memory storing instructions that, when executed by the at least one processor, cause the apparatus at least to:
receive, from a network device, a measurement configuration comprising information configuring at least one Channel State Information-Reference Signal, CSI-RS, on at least one first cell, wherein the at least one first cell is configured without Synchronization Signal Block, SSB, transmission;
determine at least one second cell where at least one associated SSB is transmitted, the at least one second cell being different from the at least one first cell; and
measure the at least one CSI-RS on the at least one first cell based on the measurement configuration and the at least one associated SSB.

2. The apparatus of claim 1, wherein the CSI-RS is measured on the at least one first cell after the at least one associated SSB on the at least one second cell is detected, wherein the CSI-RS is measured based on a timing of the at least one associated SSB.

3. The apparatus of claim 1, wherein the measurement configuration comprises an information element of the at least one associated SSB, and the information element comprises at least one of an index of the at least one associated SSB and/or identification information indicating the at least one second cell.

4. The apparatus of claim 1, wherein the apparatus is caused to:
detect the at least one associated SSB on the at least one second cell, wherein the at least one second cell is one of the following:
a primary cell,
a primary secondary cell, or
a serving cell where the at least one associated SSB is transmitted.

5. The apparatus of claim 1, wherein the apparatus is caused to:
detect the at least one associated SSB on the at least one second cell, wherein the at least one second cell is one of the following:
a serving or non-serving cell that has a same timing information with the at least one first cell,
a serving or non-serving cell with a quasi-colocation relation with the at least one first cell, or
a serving or non-serving cell, wherein a time difference between the serving or non-serving cell and the at least one first cell is below a time difference threshold.

6. The apparatus of claim 1, wherein the at least one the CSI-RS is measured within a measurement period, and wherein the measurement period is determined based on a carrier specific scaling factor, CSSF.

7. The apparatus of claim 6, wherein the apparatus is caused to:
determine the CSSF based on a number of the at least one first cell and the at least one second cell where the at least one associated SSB is transmitted; and
determine the measurement period based on the CSSF.

8. The apparatus of claim 7, wherein the apparatus is caused to:
in accordance with a determination that the at least one CSI-RS on the first cell is associated with the at least one SSB on a serving cell, increment a value of the CSSF by the number of the at least one first cell.

9. The apparatus of claim 7, wherein the apparatus is further caused to:
in accordance with a determination that the at least one CSI-RS on the at least one first cell is associated with the at least one SSB on the at least one second cell without layer 3 measurement, increment a value of the CSSF by two times of the number of the at least one first cell.

10. The apparatus of claim 7, wherein the apparatus is caused to:
in accordance with a determination that a plurality of CSI-RSs on a plurality of first cells are associated with a plurality of SSBs on the at least one second cell, determine the value of the CSSF further based on a number of the at least one second cell.

11. The apparatus of claim 1, wherein the measurement configuration is associated with layer 1 measurement or layer 3 measurement.

12. An apparatus comprising:
at least one processor; and
at least one memory storing instructions that, when executed by the at least one processor, cause the apparatus at least to:
transmit, to a terminal device, a measurement configuration comprising information configuring at least one Channel State Information-Reference Signal, CSI-RS on at least one first cell and an information element of at least one associated SSB transmitted on at least one second cell for measuring the CSI-RS, wherein the at least one first cell is configured without SSB transmission, and the at least one second cell is different from the at least one first cell.

13. The apparatus of claim 12, wherein the information element comprises at least one of:
an index of the at least one associated SSB, or
identification information indicating the at least one second cell.

14. The apparatus of claim 12, wherein the at least one second cell comprises one of the following:
a primary cell,
a primary secondary cell, or
a serving cell where the at least one associated SSB is transmitted.

15. The apparatus of claim 12, wherein the second cell comprises one of the following:
a serving or non-serving cell that has a same timing information with the at least one first cell,
a serving or non-serving cell with a quasi-colocation relation with the at least one first cell, or
a serving or non-serving cell, wherein a time difference between the serving or non-serving cell and the at least one first cell is below a time difference threshold.

16. The apparatus of claim 15, wherein the apparatus is further caused to:
transmit, to the terminal device, information related to a quasi-colocation relation between one reference signal in the at least one first cell and another reference signal in the at least one second cell.

17. A method comprising:
receiving, from a network device, a measurement configuration comprising information configuring at least one Channel State Information-Reference Signal, CSI-RS, on at least one first cell, wherein the at least one first cell is configured without Synchronization Signal Block, SSB, transmission;
determining at least one second cell where at least one associated SSB is transmitted, the at least one second cell being different from the at least one first cell; and
measuring the at least one CSI-RS on the at least one first cell based on the measurement configuration and the at least one associated SSB.

18. A method comprising:
transmitting, to a terminal device, a measurement configuration comprising information configuring at least one Channel State Information-Reference Signal, CSI-RS on at least one first cell and an information element of at least one associated SSB transmitted on at least one second cell for measuring the CSI-RS, wherein the at least one first cell is configured without SSB transmission, and the at least one second cell is different from the at least one first cell.

19. A first apparatus comprising:
means for receiving, from a network device, a measurement configuration comprising information configuring at least one Channel State Information-Reference Signal, CSI-RS, on at least one first cell, wherein the at least one first cell is configured without Synchronization Signal Block, SSB, transmission;
means for determining at least one second cell where at least one associated SSB is transmitted, the at least one second cell being different from the at least one first cell; and
means for measuring the at least one CSI-RS on the at least one first cell based on the measurement configuration and the at least one associated SSB.

20. A second apparatus comprising:
means for transmitting, to a terminal device, a measurement configuration comprising information configuring at least one Channel State Information-Reference Signal, CSI-RS on at least one first cell and an information element of at least one associated SSB transmitted on at least one second cell for measuring the CSI-RS, wherein the at least one first cell is configured without SSB transmission, and the at least one second cell is different from the at least one first cell.

21. A computer readable medium comprising instructions stored thereon for causing an apparatus at least to perform the method of claim 17 or claim 18.
